(19) United States
(12) Patent Application Publication
(10) Pub. No.: US 2004/0024486 A1
(43) Pub. Date: Feb. 5, 2004

(54) Operator assisted method for making keys

(76) Inventors: Robert E Almblad, Mundelein, IL (US); Paul Jurczak, Gurnee, IL (US)

Correspondence Address: Michael R McKenna, Suite 3800, 500 West Madison Street, Chicago, IL, 60661-2511, US

(21) Appl. No.: 10/111,022

(22) PCT Filed: Dec. 1, 2000
(86) PCT No.: PCT/US00/42438

(51) Int. Cl. G06F 19/00

(52) U.S. Cl. 700/185; 700/117; 700/95; 409/84

(57) ABSTRACT

The invention relates to operator assisted methods for making keys including automatically extracting key attributes from an object key, comparing the key attributes of the object key to known manufacturer's key attributes stored in memory of a data processing unit to identify a corresponding key blank, and verbally announcing to an operator the identity of the corresponding key blank so that the operator can secure the corresponding key blank in a clamp for cutting. In this process, the verbal announcement may comprise voice identification and a visual display. The invention relates to an improved key making machine that automatically extracts characteristics of an object key without human intervention. The position and alignment of the object key is automatically determined, key characteristics extracted and compared with known key manufacturers' information stored in memory, an appropriate key blank is identified, cut and dispensed to the customer.

The applicant claims the benefit of the following prior filed provisional application, U.S. Ser. No. 60/168,334 by the same inventors.

### TECHNICAL FIELD

This invention generally relates to methods and apparatus for semi-automatic key making.. More particularly, the invention extracts key attributes of an object key.

### BACKGROUND OF THE INVENTION

The key making art has taught us that each lock manufacturer has adopted a number of different key blanks, each with its own unique shape and specific groove characteristics. Furthermore, for each key blank its manufacturer has assigned one or more known key cut codes that define the manner in which the key blank can be cut to match the manufacturer's lock.

There are several thousand types of key blanks in the world. When a key is presented to be duplicated by a locksmith or a skilled operator of a semi-automated device, he must be skilled at working with the customer's key (object key) to determine which key blank it is among the thousands made, and he must also be skilled at trace cutting the notches (cuts or bits) of the customer's key into a correctly identified key blank. If the wrong key blank is chosen, then it will not operate in the customer's lock. Also, if the key cuts are not traced precisely, then the new key will not work in the lock.

One method of key identification is to inspect the blade of the key and any stamping, the grooves, and the length, and to match the girth of the blade in one of many slots to determine the correct key blank. In the Almblad et al. patent, U.S. Pat. No. 5,807,042, measurement of the cuts in a key and then comparing this information to the grooves and/or outer shape to new key duplicating the original can be automatically selected and cut.

Various types of key making machines currently exist which identify and utilize a key manufacturer's coding to duplicate a customer's key. U.S. Pat. Nos. 5,807,042 and 6,065,911 issued to the applicant on Jun. 7, 1997 and May 23, 2000 respectively, provide some background for the key cutting technology. Alternative technology is located in relevant patents cited in the International Search Report of applicant's PCT/US99/08957 application: U.S. Pat. No. 4,845,764 issued to Ueda et al., Jul. 4, 1984, U.S. Pat. No. 4,929,843 issued to Chmieleski, Jr., et al. on May 29, 1990, U.S. Pat. No. 5,128,531 issued to Fadel, Jul. 7, 1992; U.S. Pat. No. 5,517,299 issued to Teratani et al. in May 14, 1996, U.S. Pat. No. 4,652,765, issued to Nishihara on Mar. 24, 1987 and France Patent No. 2,489,535 issued to Gariod et al. issued in Mar. 5, 1982. However, no prior art patent known to the applicant teaches a method or apparatus that automatically extracts key cut codes of an object key to determine the proper key blank for making a new key and verbally announcing that key blank determination audibly with instructions in the operator's language and confirming said instructions with a graphic display, such as an LCD display. Nor do any prior art patents known to the applicant teach a self referential auto calibration process to correct for operator error and component wear which affects key making quality.

Earlier methods and apparatuses for key making required skill on the part of an operator to fixture the object key in some specific fashion and to have some special knowledge of key blanks with some kind of training.

The important invention disclosed herein is designed to be operated by an inexperienced operator who possesses some limited skills.

No other operator assisted device for making keys has disclosed a non-contact means for extracting laterally exposed attributes, comprising three dimensional grooves, outer shape and laterally exposed key cuts, of an object key. Nor has the prior art taught a key making apparatus or method that automatically establishes an operative positional relationship between a key blank and the key making machine.

To alleviate these problems, and others which will become apparent from the disclosure which follows, the present invention provides a key making apparatus that tells the operator what key blank to use in the machine after it is automatically determined by viewing the object key. The identification contemplated is at least one of an audio instruction and an LCD display, preferably both.

Moreover, the process can measure its own work pieces before and after cutting, and compute what errors there are from both the operator and machine wear out and any other out of adjustment factors. If the error is too great, the process will reject the key being cut, inform the operator, and then recut another key correcting for the error detected. This “auto calibration” process will enhance the quality and efficiency of making keys.

The methods extract information from an object key, extracts the attribute information necessary for it to determine the correct key blank and the correct key cut codes and a method of cutting the correct codes in to a key blank despite any deficiencies in the codes of the object key.

Attribute information is extracted by the instant apparatus automatically reading an object key and comparing the attributes of the object key with a master pattern memory of known manufacturers' keys. Then it selects the proper matching key blank and cuts it to the original key cut codes established by the manufacturer. Alternatively, the key blank can be trace-cut, duplicating the used attributes of the object key. Alternatively, key cuts hybridizing the key cut features of the object key and the key cut codes of a known manufacturer's key may be determined for use with the corresponding key blank.

### ADVANTAGES OF THIS INVENTION

Unlike the foregoing devices which teach. structures that require the precision of a trained locksmith to properly place the key correctly within a vice or similar holding device, the instant invention allows the object key to be loosely situated within a specified but yet broader area.

A preferred embodiment of the operator assisted key making machine provides a generally horizontal support surface as a means for loosely supporting the object key. The key making machine operates automatically to determine the position of the key, to extract key attributes so that a corresponding key blank can be identified, and corresponding key cut codes can be identified and cut into the corresponding key blank to make a new key conforming to the manufacturer's original specifications. Every necessary aspect of the key making process has been incorporated into the preferred embodiments of the instant apparatus.

A preferred version of the key making apparatus of the current invention, now has embodiments utilizing a stationary vision system that requires an initial back lighting sequence which provides information so that a family of possible key blanks may be determined. It further provides means for determining the initial location of the object key which is disposed loosely on the support surface.

In an earlier embodiment of the key making apparatus disclosed in U.S. Pat. No. 5,807,042, the light stripe generator and camera were mounted to a moveable arm and moved in tandem. The camera received reflected light stripe images. In the current embodiment, the camera may now be stationary, positioned above the object key support surface, and the light stripe generator may now be rotatably disposed about an axis parallel to any one of the light stripes generated on to the object key. The light stripe generator is selectively rotatable between a first position where a light stripe generated projects adjacent to an end of the object key support surface and a second position where a light stripe generated projects adjacent to the opposite end of the object key support surface.

One means for locating a rotatable position of the light stripe generator includes a limit/positioning switch which is engaged when the light stripe generator is in the first position and a second limit/positioning switch which is engaged when the light stripe generator is in the second position.

A line perpendicular to a plurality of parallel light stripes projected on to the object key is the preferred position of the longitudinal axis of the object key for determining identifying attributes of the object key. This preferred position has a rotated angle of the longitudinal axis of the object key of zero degrees. Even when the rotated angle of the longitudinal axis of the object key is approximately five degrees from the preferred position, identifying attributes of the object key can still be determined. Enhancements in imaging equipment quality have allowed these tolerances to expand accordingly.

Moreover, horizontal leveling is no longer required since attributes, including laterally protected and laterally exposed, can still be determined because the errors from shadowing, due to a rotated angle or an object key not entirely horizontal, are within the tolerances of the camera equipment. If the angular displacement of the object key is not within the tolerances of the equipment, a signal can be generated initiating a communication to the user to “straighten out the key”.

Backlighting initially provides information regarding object key placement including relative orientation of the longitudinal axis of the object key relative to the line perpendicular to the light stripes. Multiple light stripes images are processed.

In a preferred embodiment of the present invention without a rotational means for supporting an object key, a stationary mount or surface is provided upon which an operator may place an object key. This surface may have placement indicia to aid the user in situating the key. Placement indicia is an alignment guide, including any indication, symbol, sign or marking, which serves to guide the user in the placement of the object key. If the user's placement of the object key does not fit within the tolerances of the current camera's capabilities, a voice message to the operator to put the object key “straighter” relative to the alignment guide disposed on the supporting surface can be generated.

Another embodiment of the instant invention comprises a non-contact method for extracting attributes of an object key. In this method and apparatus both externally exposed and laterally protected attributes may be extracted. It involves the use of a means for receiving object images, such as a camera, which has a lens capable of viewing a shallow focal plane.

The disclosed embodiments of the instant invention can identify and produce not only American made keys, but those of Europe and throughout the world which have laterally protected cuts and curved grooves as well.

The instant semi-automatic key making apparatus provides an efficient and convenient means of making new keys. The apparatus of the present invention performs all of the required functions to achieve the objective of making a key that meets the specifications of the original manufacturer. Additionally, the methods disclosed provide that the apparatus may acquire new information about the wear down of the machine components, which may be added to the machine's database, thus, allowing the machine to auto calibrate.

Moreover, the methods disclosed herein requires little skill on the part of the operator or any knowledge of keys. Particularly when compared to the foregoing devices, the instant invention is operator-friendly. Ease of use is a critical advantage.

Still other advantages will be apparent from the disclosure that follows.

### SUMMARY OF THE INVENTION

The invention relates to methods for making keys. The operator assisted method of making keys comprises the steps of automatically extracting key attributes from an object key, comparing the key attributes of the object key to known manufacturer's key attributes stored in memory of a data processing unit to identify a corresponding key blank, verbally announcing to the operator the identity of the corresponding key blank so that the operator can secure the corresponding key blank in a clamp for cutting, and comparing the key attributes of the object key to known manufacturer's key attributes stored in memory of the data processing unit to determine a corresponding key cut code for the corresponding key blank. In this process, the verbally announcing to the operator the identity of the corresponding key blank comprises at least one of a voice identifying and a visually displaying of the identification of the corresponding key blank.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Preferred embodiments of the invention are described hereinafter with reference to the accompanying drawing wherein:

FIG. 1 is a flow diagram of a preferred embodiment of the operation of the operator assisted method of making keys showing both the manual steps undertaken by the operator and the automatic steps taken by-the apparatus described in the specification for performing the process (FIGS. 1, 2 and 3, taken together diagram the preferred processes of the operator assisted method for making keys of the present invention);

FIG. 2 is a flow diagram of a verification method showing steps to verify that the operator has clamped the proper key blank; and

FIG. 3 is a flow diagram of a preferred process of the invention which verifies that the clamped key blank has been positioned for cutting within a predetermined threshold and further showing that a process whereby the machine self adjusts for component wear.

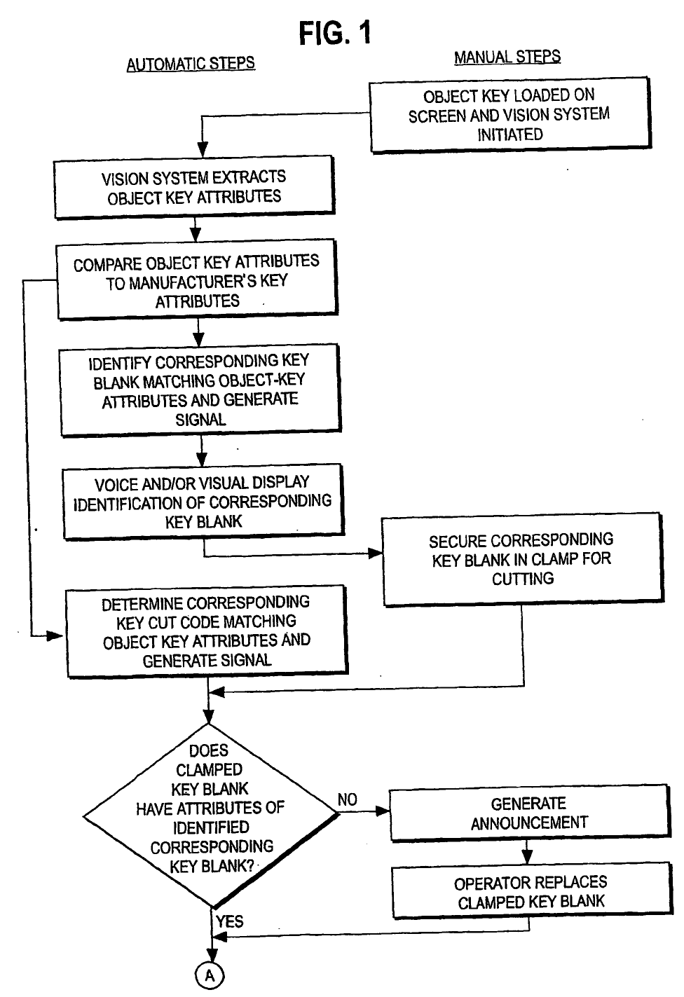

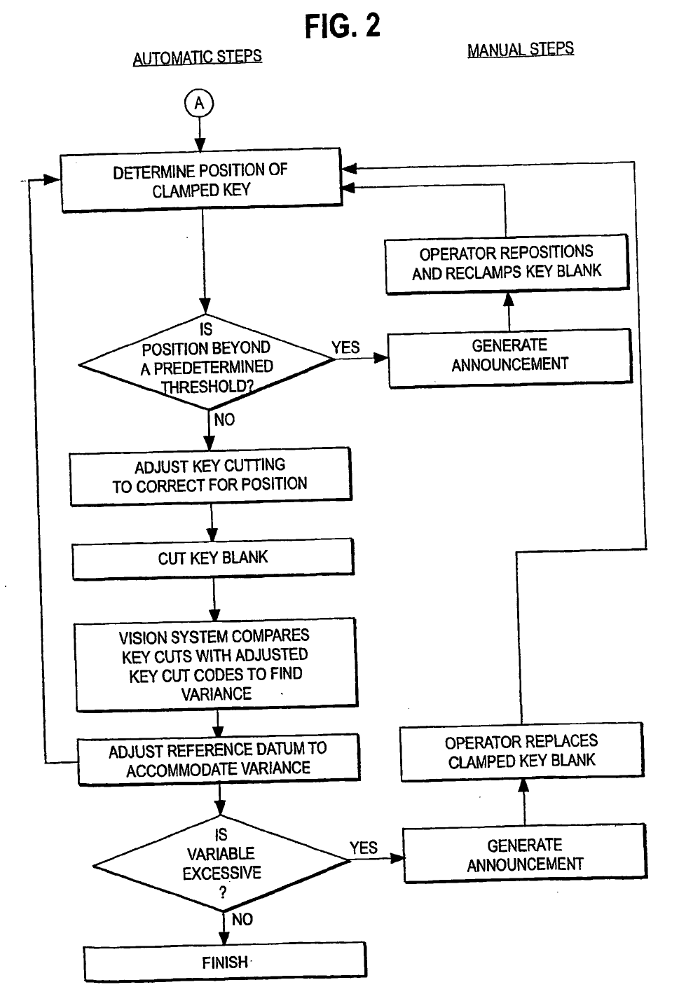

### DETAILED DESCRIPTION OF THE INVENTION

The preferred embodiments depicted in the drawing include a semi-automatic key making process, flow diagrams of preferred methods of operation, and block diagrams of various components. The discussion that follows, without limiting the scope of the invention, will refer to the invention as depicted in the drawing, showing methods that will make new keys requiring only minimum skill on the part of the operator.

An operator assisted method of making keys is provided by the instant invention. The steps include automatically extracting key attributes from an object key, comparing the key attributes of the object key to known manufacturer's key attributes stored in memory of a data processing unit to identify a corresponding key blank, and verbally announcing to the operator the identity of the corresponding key blank so that the operator can secure the corresponding key blank in a clamp for cutting. Preferably, in the operator assisted method of making keys, the verbally announcing to the operator the identity of the corresponding key blank comprises at least one of a voice identification and a visual display of the identification of the corresponding key blank.

The operator assisted method of making keys preferably includes steps of comparing the key attributes of the object key to known manufacturer's key attributes stored in memory of the data processing unit to determine a corresponding key cut code for the corresponding key blank and making key cuts in the corresponding key blank in line with the corresponding key cut code.

Additionally, the operator assisted method of making keys may comprise the steps of determining a positional relationship of the clamped key blank relative to a preselected datum and rejecting the positional relationship of the clamped key blank by generating a signal verbally announcing to the operator the need to reposition and re-clamp the key blank when the positional relationship is beyond a predetermined threshold.

Furthermore, the operator assisted method may include the steps of determining a positional relationship of the clamped key blank relative to a preselected datum, rejecting the positional relationship of the clamped key blank by generating a signal verbally announcing to the operator the need to reposition and re-clamp the key blank, when the positional relationship is beyond a predetermined threshold, and making adjustments to the key cuts to correct for the positional relationship of the key blank relative to the preselected datum.

A preferred step of the operator assisted method of making keys requires comparing the key cuts made to the corresponding key blank with manufacturer's key cuts in line with the corresponding key cut codes to determine a cutting variance and adjusting the preselected datum to correct for the cutting variance, so that any cutting variances resulting from wearing down of an element of key making equipment can be corrected. Moreover, the step of rejecting the cut key blank and generating a signal for verbally announcing to the operator that the clamped key blank needs to be replaced, when the cutting variance exceeds a predetermined amount may be included.

The operator assisted method of making keys may also comprise the steps of verifying that the key blank secured in the clamp by the operator has the key attributes of the identified corresponding key blank and rejecting the clamped key blank by generating a signal for verbally announcing to the operator that the clamped key blank needs to be replaced, when the clamped key blank fails to correspond to the identified corresponding key blank.

In another preferred process of the operator assisted method of making keys, the following steps are included:

a. determining a positional relationship of the clamped key blank relative to a preselected datum;

b. rejecting the positional relationship of the clamped key blank by generating a signal verbally announcing to the operator the need to reposition and re-clamp the key blank, when the positional relationship is beyond a predetermined threshold;

c. making adjustments to cutting key cuts to correct for the positional relationship of the key blank relative to the preselected datum;

d. comparing key cuts made to the corresponding key blank with key cuts in line with the corresponding key cut codes to determine a cutting variance and adjusting the selected datum to correct for the cutting variance; and

e. rejecting the cut key blank and informing the attendant to replace the corresponding key blank.

Another preferred process of the operator assisted method of making keys comprises the steps of automatically extracting key attributes from an object key, comparing the key attributes of the object key to known manufacturer's key attributes stored in memory of a data processing unit to identify a corresponding key blank, verbally announcing to the operator the identity of the corresponding key blank so that the operator can secure the corresponding key blank in a clamp for cutting, and comparing the key attributes of the object key to known manufacturer's key attributes stored in memory of the data processing unit to determine a corresponding key cut code for the corresponding key blank. In this process of this important invention, the verbally announcing to the operator the identity of the corresponding key blank comprises at least one of a voice identifying and a visually displaying of the identification of the corresponding key blank.

Furthermore, the operator assisted method of making keys of the foregoing preferred method may further comprise the steps of verifying that the key blank secured in the clamp by the operator has the key attributes of the identified corresponding key blank, rejecting the clamped key blank by generating a signal for verbally announcing to the operator that the clamped key blank needs to be replaced, when the clamped key blank fails to correspond to the identified corresponding key blank, determining a positional relationship of the clamped key blank relative to a preselected datum, rejecting the positional relationship of the clamped key blank by generating a signal verbally announcing to the operator the need to reposition and re-clamp the key blank, when the positional relationship is beyond a predetermined threshold, making key cuts in the corresponding key blank in line with the corresponding key cut code, comparing the key cuts made to the corresponding key blank with manufacturer's key cuts in line with the corresponding key cut codes to determine a cutting variance and adjusting the preselected datum to correct for the cutting variance, so that any cutting variances resulting from wearing down of an element of key making equipment can be corrected, and rejecting the cut key blank and generating a signal for verbally announcing to the operator that the clamped key blank needs to be replaced, when the cutting variance exceeds a predetermined amount.

One method for automatically making keys comprises establishing an operative positional relationship between an object key and a means for extracting laterally protected attributes of an object key while leaving the object key independent of forcible holding and extracting laterally protected attributes of an object key independent of physical contact.

In a preferred embodiment of the invention both laterally protected and laterally exposed attributes of an object key are recognized and compared with a master pattern memory to identify a corresponding key blank having a hole in the handle and its associated key cut code.

Another method comprises receiving an object key on a rotatable means for supporting an object key having a transparent section, backlighting the object key by passing light through a transparent section of the supporting means and projecting an object image, receiving at least one object image of the object key, determining from the object image the position of the longitudinal centerline of the object key in a generally horizontal position relative to a light stripe which may be projected on to the object key by a light stripe generator, producing an output signal corresponding to the determination, and rotating the means for supporting an object key for alignment with a line perpendicular to the light stripe.

The most current preferred method for making keys utilizing attributes of an object key having a longitudinal axis comprises loosely supporting the object key by receiving the object key on a surface, determining the initial relative orientation of the object key including computing angular displacement of a longitudinal axis of the object key relative to a line perpendicular to a fixed datum, and extracting attributes including at least one of laterally protected attributes and laterally exposed key cuts of the loosely supported object key. In this manner, key cut codes of the object key can be recognized.

Any structured light may be used for applications requiring surface feature extraction. Structured light being defined as any method, including filtering, polarizing, lensing, aperturing, and light placement at appropriate angles of incidence, that controls the light path between its source, the illuminated object and the camera.

In its preferred form, either a laser or any other collimated light source in which all of the light waves travel parallel to one another is used to produce sharply defined shadows of parts placed in its path which can be cast either directly onto a sensor or on to a flat surface where it can then be measured. Backlighting produces a silhouette image of an object contour or polyline. A preferred embodiment utilizes for a backlight source a 7 watt bulb with a light diffuser of opaque plastic.

A key method of establishing an operative positional relationship between an object key and a means for extracting attributes of an object key while leaving the object key independent of constraint and may be employed with any known method of extracting attributes of an object key including-those utilizing physical contact.

The present invention provides that the means for receiving an object image comprises at least one camera, the camera being a pixel device for oriented fiber optic arrays. The camera is available from a number of manufacturers and is a 256 grey scale charge-coupled device (CCD) high resolution camera and a 4/40 lens. Signal output of the camera is sent to a frame grabber installed in the computing means. A standard 486 PC or higher capacity data processing unit may act as the computing means.

Some of the identifying attributes of an object key are disposed on its silhouette. These laterally exposed attributes may include the outer shape, and the exposed key cuts. Other identifying attributes of an object key cannot be seen on the silhouette. Such laterally protected attributes may include groove characteristics extending longitudinally along the blade of an object key or as laterally protected key cuts or recessed dimples. Additionally, the silhouette view provides information about the location of the handle and the blade of the object key, so that the light stripe generator can be positioned to project a light stripe on to the object key where its grooves begin.

A means is provided for storing memory data of rejected object keys. These object keys are rejected because they do not have corresponding master code signals matching the code signals from the result of said recognition of the pixel pattern of the object key. By storing memory data of rejected object keys, the key making apparatus may acquire additional information about keys that are not as yet available in its master pattern memory. This can serve to assist in the expansion of the memory database.

A laser adapted to produce an array which forms a line may be applied.

Furthermore, the light stripe method functions to recognize laterally protected attributes of the object key which result from capturing the image of at least one light stripe being projected obliquely on to the blade thereof.

A preferred process involves the following steps: projecting at least one light stripe obliquely on to an object key; receiving an object image of the light stripe of laterally protected attributes of the object key, recognizing a pixel pattern from the object image, producing a series of code signals that define traits of the recognized pixel pattern for each target pixel from the result of the recognition, comparing the code signals with master code signals from a master pattern memory, the master code signals defining traits of a master pixel pattern of a selected manufacturer's key, and producing an identifying signal from such comparison, the identifying signal defining a corresponding key blank with a predetermined master pattern having master code signals that match code signals from the result of the recognition of the pixel pattern of the object key. In addition, key cut codes may also be identified utilizing this method.

The key cut attributes of the object key are extracted by the backlighting method previously discussed. If the key cut codes of an identified key blank fail to match up, then the “expert” rejection mode is initiated.

The identifying signal of the key making apparatus, may further defines both a key cut code and key cut features of the object key that correspond generally with key cut codes identified with the corresponding key blank.

It will be obvious to one skilled in the art of image recognition that other methods employing optical character recognition, magnetic resonance imaging, or hologramatic imaging could be utilized. Moreover, an apparatus employing other known light generators and light receivers, could easily be employed.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims.

Furthermore, the purpose of the foregoing abstract is to enable the U.S. Patent and Trademark Office and the public generally, and especially the scientist, engineers and practitioners in the art who are not familiar with patent or legal terms of phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention are pointed out with particularity in the claims annexed to and forming a part of this disclosure. For a better understanding of the invention, its operating advantages and the specific objects attained by its uses, reference should be made to the accompanying drawing and descriptive matter in which there is illustrated preferred embodiments of the invention.

What is claimed as being new and desired to be protected is a follows:

1. An operator assisted method of making keys comprising the steps of:
a. automatically extracting key attributes from an object key;
b. comparing the key attributes of the object key to known manufacturer's key attributes stored in memory of a data processing unit to identify a corresponding key blank; and
c. verbally announcing to the operator the identity of the corresponding key blank, whereby, the operator can secure the corresponding key blank in a clamp for cutting.

2. The operator assisted method of making keys of claim 1, further comprising the step of comparing the key attributes of the object key to known manufacturer's key attributes stored in memory of the data processing unit to determine a corresponding key cut code for the corresponding key blank.

3. The operator assisted method of making keys of claim 1, wherein the verbally announcing to the operator the identity of the corresponding key blank comprises at least one of a voice identification and a visual display of the identification of the corresponding key blank.

4. The operator assisted method of making keys of claim 2, further comprising the step of making key cuts in the corresponding. key blank in line with the corresponding key cut code.

5. The operator assisted method of making keys of claim 1, further comprising the steps of:
a. determining a positional relationship of the clamped key blank relative to a preselected datum; and
b. rejecting the positional relationship of the clamped key blank by generating a signal verbally announcing to the operator the need to reposition and re-clamp the key blank, when the positional relationship is beyond a predetermined threshold.

6. The operator assisted method of making keys of claim 4, further comprising the steps of:
a. determining a positional relationship of the clamped key blank relative to a preselected datum;
b. rejecting the positional relationship of the clamped key blank by generating a signal verbally announcing to the operator the need to reposition and re-clamp the key blank, when the positional relationship is beyond a predetermined threshold; and
c. making adjustments to the key cuts to correct for the positional relationship of the key blank relative to the preselected datum.

7. The operator assisted method of making keys of claim 4, further comprising the step of comparing the key cuts made to the corresponding key blank with manufacturer's key cuts in line with the corresponding key cut codes to determine a cutting variance and adjusting the preselected datum to correct for the cutting variance,
whereby, any cutting variances resulting from wearing down of an element of key making equipment can be corrected.

8. The operator assisted method of making keys of claim 7, further comprising the step of rejecting the cut key blank and generating a signal for verbally announcing to the operator that the clamped key blank needs to be replaced, when the cutting variance exceeds a predetermined amount.

9. The operator assisted method of making keys of claim 1, further comprising the steps of:
a. verifying that the key blank secured in the clamp by the operator has the key attributes of the identified corresponding key blank; and
b. rejecting the clamped key blank by generating a signal for verbally announcing to the operator that the clamped key blank needs to be replaced, when the clamped key blank fails to correspond to the identified corresponding key blank.

10. An operator assisted method of making keys comprising the steps of:
a. determining a positional relationship of the clamped key blank relative to a preselected datum;
b. rejecting the positional relationship of the clamped key blank by generating a signal verbally announcing to the operator the need to reposition and re-clamp the key blank, when the positional relationship is beyond a predetermined threshold;
c. making adjustments to cutting key cuts to correct for the positional relationship of the key blank relative to the preselected datum;
d. comparing key cuts made to the corresponding key blank with key cuts in line with the corresponding key cut codes to determine a cutting variance and adjusting the selected datum to correct for the cutting variance; and
e. rejecting the cut key blank and informing the attendant to replace the corresponding key blank.

11. An operator assisted method of making keys comprising the steps of:
a. automatically extracting key attributes from an object key;
b. comparing the key attributes of the object key to known manufacturer's key attributes stored in memory of a data processing unit to identify a corresponding key blank;
c. verbally announcing to the operator the identity of the corresponding key blank, whereby, the operator can secure the corresponding key blank in a clamp for cutting,
wherein the verbally announcing to the operator the identity of the corresponding key blank comprises at least one of a voice identifying and a visually displaying of the identification of the corresponding key blank; and
d. comparing the key attributes of the object key to known manufacturer's key attributes stored in memory of the data processing unit to determine a corresponding key cut code for the corresponding key blank.

12. The operator assisted method of making keys of claim 11, further comprising the steps of:
a. verifying that the key blank secured in the clamp by the operator has the key attributes of the identified corresponding key blank;
b. rejecting the clamped key blank by generating a signal for verbally announcing to the operator that the clamped key blank needs to be replaced, when the clamped key blank fails to correspond to the identified corresponding key blank;
c. determining a positional relationship of the clamped key blank relative to a preselected datum;
d. rejecting the positional relationship of the clamped key blank by generating a signal verbally announcing to the operator the need to reposition and re-clamp the key blank, when the positional relationship is beyond a predetermined threshold;
e. making key cuts in the corresponding key blank in line with the corresponding key cut code;
f. comparing the key cuts made to the corresponding key blank with manufacturer's key cuts in line with the corresponding key cut codes to determine a cutting variance and adjusting the preselected datum to correct for the cutting variance,
whereby, any cutting variances resulting from wearing down of an element of key making equipment can be corrected; and
g. rejecting the cut key blank and generating a signal for verbally announcing to the operator that the clamped key blank needs to be replaced, when the cutting variance exceeds a predetermined amount.
